(19) United States
(12) Patent Application Publication
(10) Pub. No.: US 2026/0243876 A1
(43) Pub. Date: Aug. 20, 2026

(54) SHAPE ESTIMATION SYSTEM, OBJECT DETECTION SYSTEM, COMMUNICATION SYSTEM, SHAPE ESTIMATION METHOD, OBJECT DETECTION METHOD, AND COMMUNICATION METHOD

(71) Applicant: Astemo, Ltd., Chiyoda-ku, Tokyo (JP)

(72) Inventors: Makoto HOSAKA, Hitachinaka-shi, Ibaraki (JP); Hikari MIKAMI, Hitachinaka-shi, Ibaraki (JP); Satoshi ITO, Hitachinaka-shi, Ibaraki (JP); Yusuke NOMA, Hitachinaka-shi, Ibaraki (JP); Ryo SAKURAI, Hitachinaka-shi, Ibaraki (JP)

(73) Assignee: Astemo, Ltd., Chiyoda-ku, Tokyo (JP)

(21) Appl. No.: 19/164,347

(22) PCT Filed: May 12, 2023
(86) PCT No.: PCT/JP2023/017997

§ 371 Date: Sep. 11, 2025

(51) Int. Cl. G01S 7/539; G01S 15/88

(52) U.S. Cl. CPC G01S 7/539; G01S 15/88

(57) ABSTRACT

The present invention stores, as detection data, the distance between a vehicle 1 and a detected object 3 acquired based on the time from when a transmission wave 2A is transmitted to when a reception wave 2B scattered/reflected from the detected object 3 is received, and an amplitude value/intensity value of the reception wave 2B corresponding to the distance, resamples, as sampling data of a desired distance, the amplitude value/intensity value of the reception wave 2B corresponding to the distance between the vehicle 1 and the detected object 3, converts the resampling data from the spatial region to the spatial frequency region, saves a set of spectra in the spatial frequency region for a plurality of preset object shapes as a database in association with the object shape, and estimates the shape of the detected object 3 based on the spectrum of the detected object 3 and the saved set of spectra. Furthermore, the present invention estimates, as the shape of the detected object 3, the object shape corresponding to the spectrum, among the set of spectra, which is closest to the spectrum of the detected object 3.

### TECHNICAL FIELD

The present invention relates to a shape estimation system, an object detection system, and a communication system for a vehicle that detect objects present around the vehicle and estimate the shapes of the objects, as well as a shape estimation method, an object detection method, and a communication method.

### BACKGROUND ART

For example, PTL 1 discloses a technique for estimating whether objects present around a vehicle are human beings. PTL 1 discloses: “The human being detection device according to the embodiment acquires detection information from an ultrasonic sensor that has received a reflected wave of an ultrasonic wave transmitted to a predetermined area. The reflected wave waveform according to the detection information is normalized based on the distance of the ultrasonic wave to the reflective object and distance-dependent attenuation characteristic information relating to the ultrasonic wave. In a case where the peak of the normalized reflected wave waveform is greater than or equal to a predetermined threshold, it is determined that an object is detected in a predetermined region. In a case where an object is detected by an object detection unit, a reflected wave waveform of a predetermined range including the peak is extracted from the normalized reflected wave waveform. A plurality of parameters is generated by performing predetermined frequency analysis on the reflected wave waveform of the predetermined range without losing time information. A parameter for discriminating whether an object is a human being is extracted from among the plurality of parameters. A discrimination of whether the object is a human being is made based on the extracted parameter”.

### CITATION LIST

### Patent Literature

PTL 1: JP 2022-142252 A

### SUMMARY OF INVENTION

### Technical Problem

In a vehicle control system, a technique for detecting objects present around the ego-vehicle is important in order to control an ego-vehicle to a desired position safely and appropriately. It is also desirable not only to recognize the presence or absence of objects around the ego-vehicle but also to be able to estimate the shapes of the detected objects.

For example, in a vehicle control system typified by automatic parking and parking assistance, it is possible to switch a vehicle control method by recognizing the shape of an object, such as whether the object is a vehicle or a curbstone/car stop.

Incidentally, in a shape estimation system for a vehicle control system, it is desirable to be able to estimate the type of the detected object with high accuracy, and it is convenient to be able to estimate not only the type of the object, but also the dimensions.

However, in the case of the system/device/technology disclosed in PTL 1 and the like, in a type estimation, there is likelihood of an improvement in accuracy based on a theoretical calculation result and an actual measurement result. In addition, a technique for performing a dimension estimation is not disclosed.

The present invention was conceived of in view of the above problems, and the purpose of the present invention is to provide a shape estimation system, an object detection system, and a communication system that enable the types and dimensions of objects present around an ego-vehicle to be estimated with high accuracy, as well as a shape estimation method, an object detection method, and a communication method.

### Solution to Problem

The present invention includes multiple means for solving the above problem, but one example is a shape estimation system for a vehicle, the system including: a storage unit that stores, as detection data, the distance between the vehicle and a detected object, and an amplitude value/intensity value of a wave corresponding to the distance, the distance being acquired based on the time from when a transmission wave is transmitted from a transmission unit which transmits the transmission wave to a detection area to be observed to when the wave is received by a reception unit which receives the wave scattered/reflected from the detected object present in the detection area; a resampling unit that resamples, based on the detection data, an amplitude value/intensity value of the wave corresponding to the distance between the vehicle and the detected object as sampling data of a desired distance; a conversion processing unit that converts the resampling data which is output from the resampling unit from a spatial domain into a spatial frequency domain; a saving unit that saves a set of spectra in the spatial frequency domain for a plurality of preset object shapes as a database in association with the object shape; and a shape estimation unit that estimates the shape of the detected object based on the spectrum of the detected object output from the conversion processing unit and the set of spectra saved in the saving unit, wherein the shape estimation unit estimates, as the shape of the detected object, the object shape corresponding to the spectrum, among the set of spectra in the saving unit, which is closest to the spectrum of the detected object output from the conversion processing unit.

### Advantageous Effects of Invention

With the present invention, it is possible to estimate the types and dimensions of objects present around an ego-vehicle with high accuracy. Problems, configurations, and effects other than those described above will be clarified by the description of the embodiments hereinbelow.

### BRIEF DESCRIPTION OF DRAWINGS

FIG. 1 is a block diagram illustrating an example of an overall configuration of a vehicle equipped with a shape estimation system according to a first embodiment of the present invention.

FIG. 2 is a schematic diagram illustrating an example of spatial arrangement of a vehicle, transmission/reception waves, and an object at the time of object detection.

FIG. 3 is a diagram illustrating examples of waveforms of a detection signal in a vehicle at the time of object detection and signals processed in the shape estimation system.

FIG. 4 is an explanatory diagram illustrating an embodiment of an object type estimation performed by the shape estimation system.

FIG. 5 is an explanatory diagram illustrating an embodiment of an object dimension estimation performed by the shape estimation system.

FIG. 6 illustrates an example of the flow of processing by the shape estimation system according to the first embodiment of the present invention.

FIG. 7A is a diagram illustrating an example of a waveform when the technical validity of the shape estimation system according to the first embodiment of the present invention is verified by simulation.

FIG. 7B is a diagram illustrating an example of a waveform when the technical validity of the shape estimation system according to the first embodiment of the present invention is verified by simulation.

FIG. 7C is a diagram illustrating an example of a waveform when the technical validity of the shape estimation system according to the first embodiment of the present invention is verified by simulation.

FIG. 7D is a diagram illustrating an example of a waveform when the technical validity of the shape estimation system according to the first embodiment of the present invention is verified by simulation.

FIG. 8 is a diagram illustrating an example of an estimation result when the technical validity of the shape estimation system according to the first embodiment of the present invention is verified by simulation.

FIG. 9 is a diagram illustrating an example of a relationship between an error rate and a noise amount when the technical validity of the shape estimation system according to the first embodiment of the present invention is verified by simulation.

FIG. 10 is a block diagram illustrating an example of the overall configuration of a vehicle equipped with a shape estimation system and of a communication system according to a second embodiment of the present invention.

### DESCRIPTION OF EMBODIMENTS

Hereinafter, embodiments of a shape estimation system, an object detection system, and a communication system, as well as a shape estimation method, an object detection method, and a communication method of the present invention will be described with reference to the drawings. Note that the present invention is not limited to the embodiments described below, and various modifications can be made within the scope of the technical idea. In the drawings used in the present specification, the same or corresponding components are denoted by the same or similar reference numerals, and repeated description of these components may be omitted.

### First Embodiment

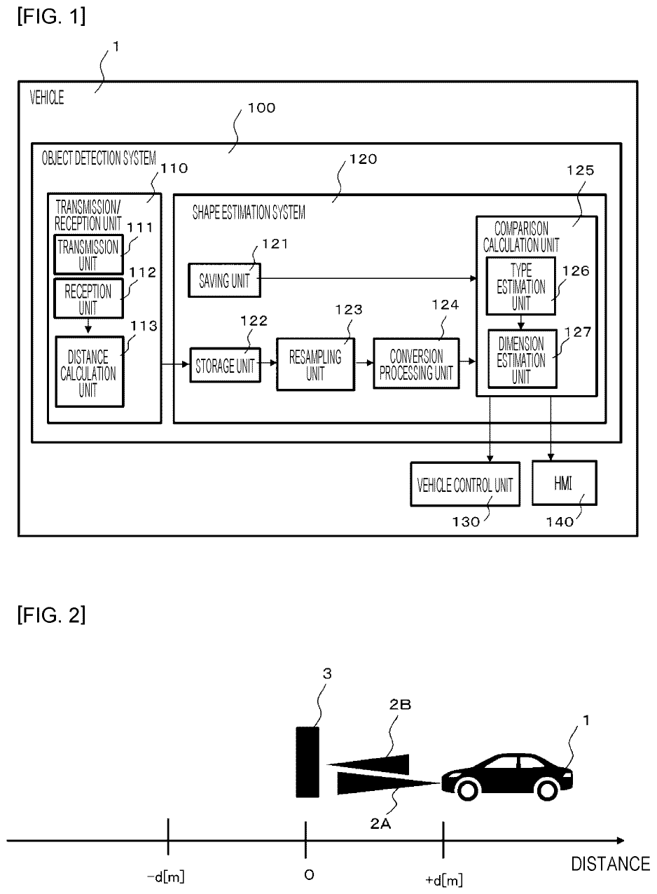

A first embodiment of a shape estimation system, an object detection system, and a communication system, as well as a shape estimation method, an object detection method, and a communication method of the present invention will be described with reference to FIGS. 1 to 9.

First, an overall configuration of a vehicle equipped with the shape estimation system will be described with reference to FIG. 1. FIG. 1 is a block diagram illustrating an example of the overall configuration of a vehicle equipped with the shape estimation system according to the first embodiment of the present invention.

As illustrated in FIG. 1, a vehicle 1 includes an object detection system 100, a vehicle control unit 130, and an HMI (Human Machine Interface) 140. Although there are many function blocks included in the vehicle 1, only the function blocks related to the present invention are illustrated.

The object detection system 100 includes a transmission/reception unit 110 and a shape estimation system 120 and is capable of detecting objects present around the vehicle and also estimating the shapes of the objects.

The transmission/reception unit 110 includes a transmission unit 111 that transmits a transmission wave 2A (see FIG. 2) to a detection area to be observed, a reception unit 112 that receives a reception wave 2B (see FIG. 2) scattered/reflected from a detected object 3 present in the detection area, and a distance calculation unit 113 that obtains the distance between the vehicle 1 and the detected object 3 based on the time from when the transmission wave 2A is transmitted from the transmission unit 111 to when the reception unit 112 receives the reception wave 2B, and the transmission/reception unit 110 projects waves in a desired range from the transmission unit 111 in order to detect objects around the vehicle.

Here, as the transmission wave 2A transmitted by the transmission unit 111 and the reception wave 2B received by the reception unit 112, for example, ultrasonic waves, optical waves, a laser considered to have particularly high coherence among optical waves, radio waves, or the like are assumed. In the present invention, future descriptions will be made using ultrasonic waves as an example.

In a case where an object is present in the detection range, the reception unit 112 receives a scattered/reflected wave from the object. Thereafter, the distance calculation unit 113 receives an output signal from the reception unit 112, and calculates the distance between the vehicle 1 and the object from the time from when the wave is transmitted by the transmission unit to when the wave is received by the reception unit. Here, this time can be considered as the time required for reciprocating propagation between the vehicle 1 and the object.

The shape estimation system 120 includes a saving unit 121, a storage unit 122, a resampling unit 123, a conversion processing unit 124, and a comparison calculation unit 125.

The saving unit 121 is a storage medium that saves, as a database, a set of spectra in a spatial frequency domain for a plurality of preset object shapes in association with the object shapes, and saves, in association with the objects, information of the set of spectra in the spatial frequency domain of scattered/reflected waves corresponding to the plurality of objects. This set of spectra may be created, for example, based on simulation or may be created based on actual measurement data.

The storage unit 122 is a recording medium that stores, as detection data, the distance between the vehicle 1 and the detected object 3 and an amplitude value/intensity value of the reception wave 2B corresponding to the distance, the distance being acquired based on the time from when the transmission wave 2A is transmitted from the transmission unit 111 transmitting the transmission wave 2A to the detection area to be observed to when the reception wave 2B scattered/reflected from the detected object 3 present in the detection area is received by the reception unit 112 receiving the reception wave 2B.

The resampling unit 123 is a part that resamples the amplitude value/intensity value of the reception wave 2B corresponding to the distance between the vehicle 1 and the detected object 3 as sampling data of a desired distance based on the detection data recorded in the storage unit 122. This is because, when the driver or the system controls the vehicle, it is assumed that the vehicle repeatedly moves forward or backward depending on the situation, and there is not necessarily any data enabling the shape estimation system 120 to easily estimate the shape of the object, and thus it is necessary to perform processing in order to obtain the desired data.

Here, as an example of the resampling processing, it is conceivable to perform, for example, operation processing in order to calculate amplitude value/intensity value data when the distance between the vehicle and the object changes at regular intervals.

The conversion processing unit 124 is a part that converts the resampling data output from the resampling unit 123 from the spatial region to the spatial frequency region. For example, the amplitude value/intensity value resampled by the resampling unit 123 is input, and the conversion processing unit 124 converts the data in the spatial region, for example, into spatial frequency region data. Note that, in the present description, processing for conversion to the spatial frequency domain has been described as an example, but the present invention is not limited to this conversion processing, rather, it is considered possible to use various conversion methods.

The comparison calculation unit 125 is a part that includes a type estimation unit 126 and a dimension estimation unit 127 and that estimates the shape of the detected object 3 based on the spectrum of the detected object 3 which is output from the conversion processing unit 124 and the set of spectra saved in the saving unit 121. In the present embodiment, the comparison calculation unit 125 estimates, as the shape of the detected object 3, the object shape corresponding to the spectrum, among the set of spectra in the saving unit 121, which is closest to the spectrum of the detected object 3 output from the conversion processing unit 124.

In particular, the type estimation unit 126 estimates the type of the detected object 3 as the shape estimation of the detected object 3. Here, in the type estimation, for example, the type estimation unit 126 is capable of performing machine learning of the features of each type by using, as training data, data among the set of spectra which is prepared in advance as a database in the saving unit 121 and corresponding object shape information, and of estimating the type from the measured spectrum of the detected object 3 based on the result of the machine learning. Alternatively, the type estimation unit 126 may calculate, for each object type, the average value of the difference between the set of spectra prepared in advance as a database in the saving unit 121 and the measured spectrum, and estimate the type for which the average value of this difference is substantially minimum as the type of the object to be observed.

In particular, the dimension estimation unit 127 estimates the dimensions of the detected object 3 as the shape estimation of the detected object 3. Here, in the dimension estimation, for example, a method may be considered in which so-called scatterometry is employed to perform the dimension estimation by comparing a database prepared in advance with actual measurement data. However, in normal scatterometry, the approximate shape of an object is known, or the measurement technique is the same every time, and thus dimension estimation is relatively easy. However, in the case of a vehicle, the method of approach, such as the speed with which the object is approached or the number of repetitions of forward/backward movement, is different every time, and hence it is not easy to employ this technique.

In addition, various cases such as where the observation target is a wall, a vehicle, a pole, or a curbstone are conceivable, and hence it is not easy to employ normal scatterometry. Therefore, as described above, irrespective of the particular case when using the vehicle approach method, it is conceivable that the resampling unit 123 performs the resampling processing so as to obtain a data format which is convenient for performing the shape estimation.

Furthermore, in the comparison calculation unit 125, for example, the type estimation unit 126 narrows down the types in advance, and then the dimension estimation unit 127 performs a dimension estimation wherein the dimension estimation of an object to be observed can be performed by employing scatterometry.

As an example of the processing by the dimension estimation unit 127, for example, a method may be considered that involves extracting a set of spectra prepared in advance as a database in the saving unit 121 only for the type estimated by the type estimation unit 126, calculating the difference between the set of spectra which is actually extracted and the measured spectrum, and estimating dimensions for which the difference is substantially minimum as the dimensions of the object to be observed. With the above method, it is also possible to apply this technique to a vehicle, in which case there is a high degree of operational freedom, the object to be observed is also unknown, and it is extremely difficult to employ scatterometry, and the technique makes it possible to perform an estimation of the shape of the object to be observed.

The vehicle control unit 130 inputs shape information of the object to be observed from the comparison calculation unit 125, for example, and changes the method for controlling the vehicle according to the type and dimensions of the object.

The HMI 140 inputs shape information of the object to be observed from the comparison calculation unit 125, for example, and notifies the driver of the object information.

FIG. 2 illustrates an example of spatial arrangement of a vehicle, transmission/reception waves, and an object at the time of object detection. The transmission wave 2A emitted from the vehicle 1 is scattered/reflected by the detected object 3 and detected by the vehicle 1 as the reception wave 2B. At the time of object detection, for example, it is conceivable that the vehicle 1 approaches the detected object 3 from the positive direction on the drawing to the direction of the origin O, and it is possible to estimate the shape of a target object that the vehicle is approaching at this time.

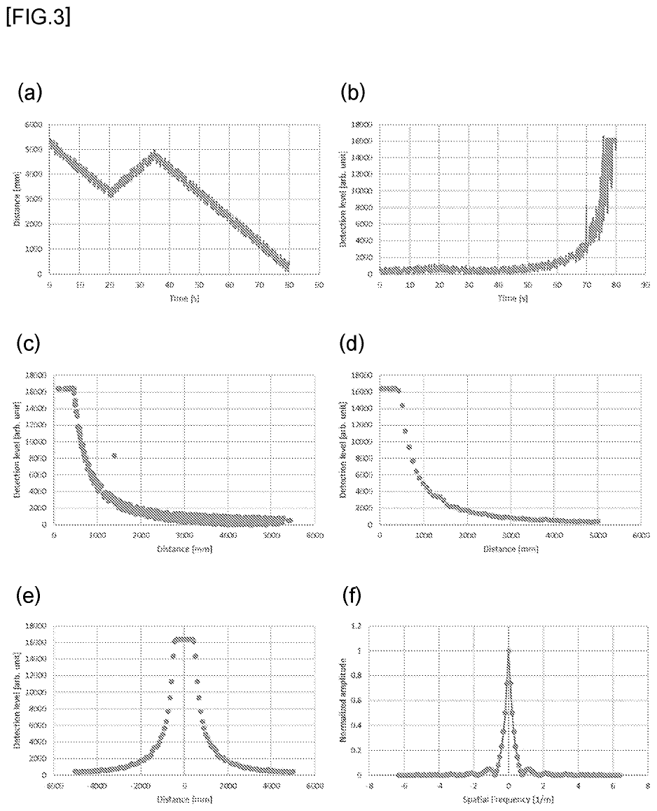

FIG. 3 illustrates examples of waveforms of a detection signal in a vehicle at the time of object detection and signals processed in the shape estimation system.
(a) in FIG. 3 illustrates an example of a temporal change in the distance between the vehicle and the object. In the example of the drawing, the vehicle approaches the object first, moves away from the object once and then approaches the object again, which is considered to be a case where the vehicle is controlled to a target parking space in a parking lot.
(b) in FIG. 3 illustrates an example of a temporal change in the detection level of a wave scattered/reflected from an object. The level value tends to increase as the object is approached. Note that this example illustrates an example of a 14-bit detection range, and the detection level is saturated at 16384.
(c) in FIG. 3 illustrates an example in which the distance between the vehicle and the object is plotted on the horizontal axis and the detection level of the wave scattered/reflected from the object is plotted on the vertical axis. It can be seen that a specific noise is generated in the vicinity of the distance of 1080 mm. In addition, random noises are generated overall, and these noises affect shape estimation, thus necessitating countermeasures. In addition, because the plotted data is not data at a desired distance interval, it is desirable to perform the resampling processing as described above.

Therefore, the resampling unit 123 is capable of calculating the sampling data, among the data included in the detection data, by computing the average value of amplitude values/intensity values of the reception wave 2B which falls within a predetermined distance range from the desired distance.

For example, (d) of FIG. 3 illustrates an example of the relationship between the distance and the detection level after the resampling processing. In the resampling, for example, as described above, the detection level value is subjected to the resampling processing so as to obtain sampling data at equal intervals. In the case of calculating the detection level value at a desired distance, for example, a method may be considered which involves extracting detection level values pertaining to a predetermined distance range from a desired distance, and calculating the average value. As a result, the impact of random noise and specific noise can be reduced as illustrated in (d) of FIG. 3.
(e) of FIG. 3 illustrates an example of the relationship between the distance and the detection level after preprocessing in the conversion processing is performed. For example, because periodic boundary conditions are assumed in a case where the discrete Fourier transform is performed as the transform processing, it is desirable that the detection level value at the minimum distance and the detection level value at the maximum distance be substantially the same. In order to meet this requirement, generally, application of a window function or the like is performed, but the original detection waveform is intentionally deformed, which leads to a decrease in the accuracy of shape estimation of the object.

Therefore, after combining the resampling data output from the resampling unit 123 and the data obtained by inverting the sign of the distance of the resampling data, the conversion processing unit 124 can perform conversion processing from a spatial domain to a spatial frequency domain.

For example, as illustrated in (e) of FIG. 3, a possible approach is to preprocess data to suit periodic boundary conditions by combining data obtained by inverting the sign of the distance. Here, the data obtained by inverting the sign of the distance corresponds to acquired data in the area where the distance is negative in FIG. 2, and can be considered as, for example, acquired data which is acquired when the same detected object 3 is detected by the transmission/reception unit provided at the rear of the vehicle 1. That is, the data in (e) of FIG. 3 can be considered to be data for which it is assumed that data of the same detection level value as data acquired in a region with a positive distance can also be acquired in a region with a negative distance.
(f) of FIG. 3 illustrates an example of a spectrum when the data of the detection level illustrated in (e) of FIG. 3 is subjected to the discrete Fourier transform.

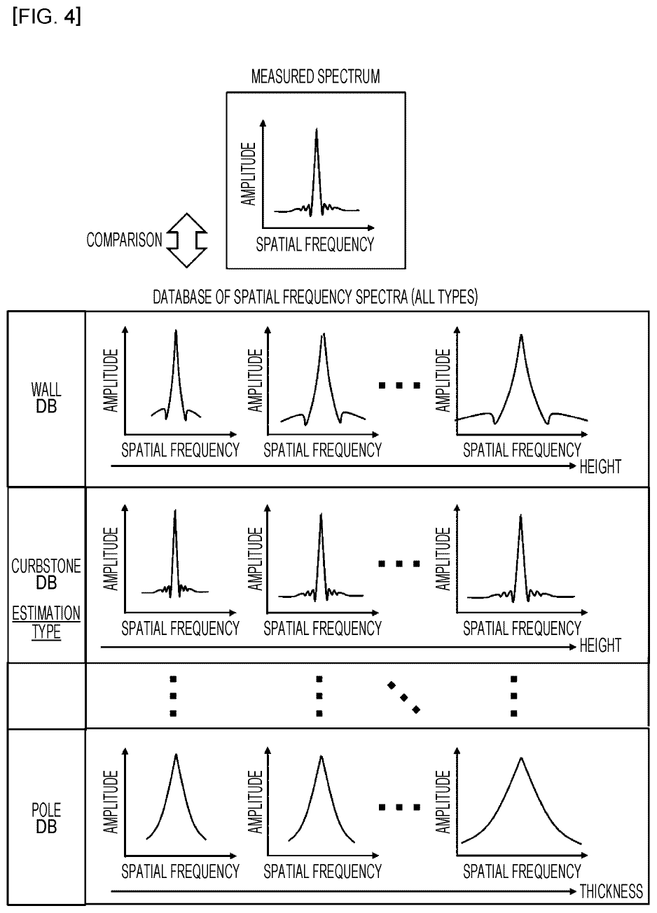

FIG. 4 illustrates an embodiment of an object type estimation performed by the shape estimation system. When performing a type estimation, for example, the shape estimation system estimates the type of the object to be observed by comparing the measured spectrum with a set of spectra which is prepared in advance as a database.

As the database, for example, a set of spectra for when the dimensions such as the height and thickness are changed for each type of wall, curbstone, pole, and the like is saved. As described above, for example, the shape estimation system machine-learns spectral features for each type based on information of the set of spectra in this database, and utilizes this learning data to estimate the type of the object to be observed from the measured spectrum.

Alternatively, the shape estimation system is capable of calculating, for each type, the average value of the difference between the set of spectra in the database saved in the saving unit 121 and the spectrum of the detected object 3 constituting the actual measurement data, and of estimating the type for which the average value of this difference is minimum, as the type of the detected object 3. Note that the minimum value may not be accurately obtained, and hence may be a substantially minimum value. Here, the substantially minimum type may be estimated as the type of the object to be observed. Note that the set of spectra saved as the database may be prepared by simulation or using actual measurement data.

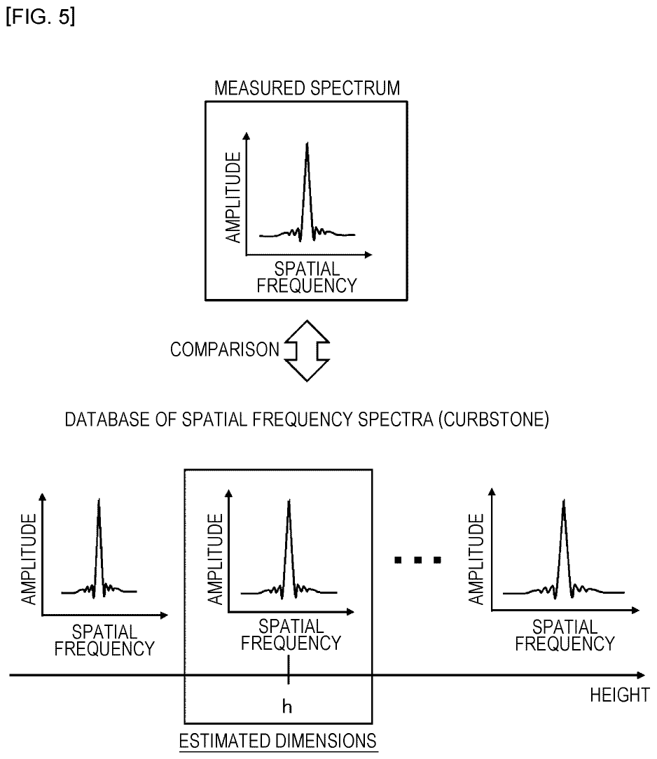

FIG. 5 illustrates an embodiment of an object dimension estimation performed by the shape estimation system.

When the dimension estimation is performed by the dimension estimation unit 127 at the time of the shape estimation of the detected object 3, because it is considered that the type of the object to be observed has already been estimated by the type estimation unit 126, the dimension estimation unit 127 is capable of estimating the dimensions of the detected object 3 after referring only to data, among the set of spectra, related to the identified type of the detected object 3.

For example, the dimension estimation unit 127 estimates the dimensions at which the difference between the measured spectrum and the set of spectra saved as the database is substantially minimum as the dimensions of the detected object 3 to be observed. Alternatively, the dimensions may be estimated using machine learning. Note that the set of spectra saved as the database may be prepared by simulation or using actual measurement data.

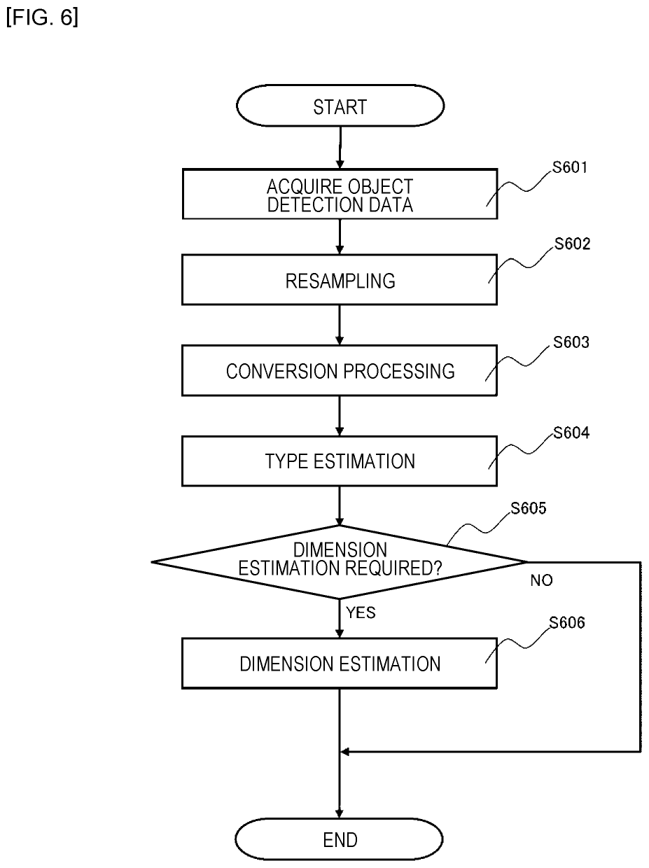

FIG. 6 illustrates an example of the flow of processing by the shape estimation system according to the first embodiment of the present invention.

First, detection data related to an object to be observed is acquired in S601. As described above, for example, the distance between the vehicle and the object and the amplitude value/intensity value of the scattered wave/reflected wave from the object are considered as the detection data.

Thereafter, the detection data acquired in S602 is subjected to resampling processing. Here, for example, the amplitude value/intensity value is resampled so as to be data acquired at equal intervals.

Thereafter, in S603, the resampled amplitude value/intensity value is converted. Here, for example, a spectrum in the spatial frequency domain is obtained by performing conversion processing from a spatial domain to a spatial frequency domain.

Thereafter, in S604, the type of the object to be observed is estimated. Here, for example, the type of the object to be observed is estimated by comparing a set of spectra prepared in advance as a database with a measured spectrum.

Thereafter, it is determined in S605 whether or not the dimension estimation is necessary. In a case where the dimension estimation is not necessary, the processing is ended, and in a case where the dimension estimation is necessary, the processing is ended after the dimension estimation in S606 is performed. Here, with regard to whether or not the dimension estimation is necessary, for example, in a case where the object to be observed is a curbstone or a car stop, measures may be considered such as making a dimension estimation in cases such as where it is better to determine whether or not there is a collision by performing a comparison with the bumper height of the vehicle.

In the dimension estimation in S606, for example, a set of spectra prepared in advance as a database only for the estimated type is extracted, and the measured spectrum and this set of spectra are compared to estimate the dimensions of the object to be observed.

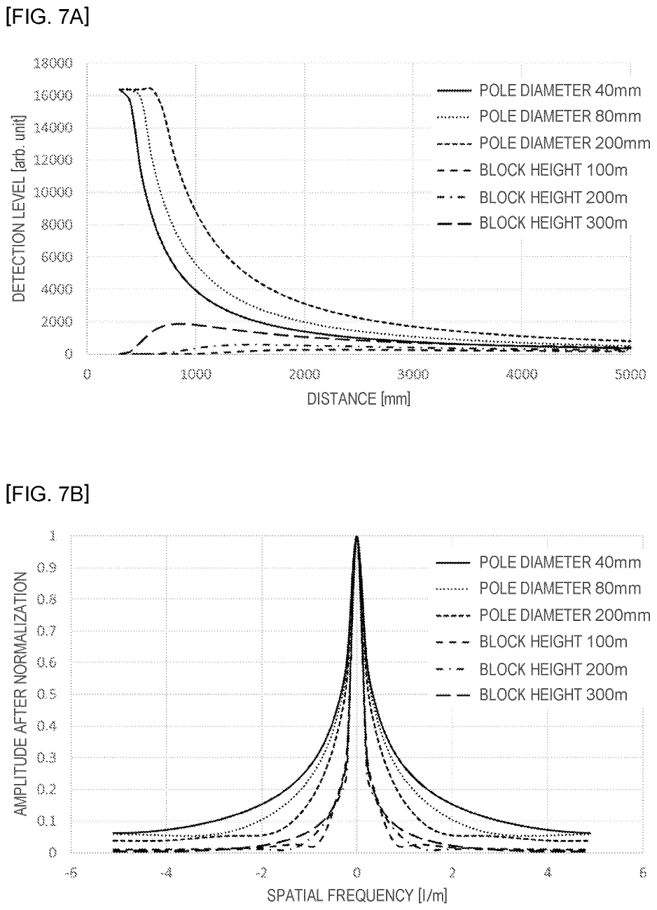

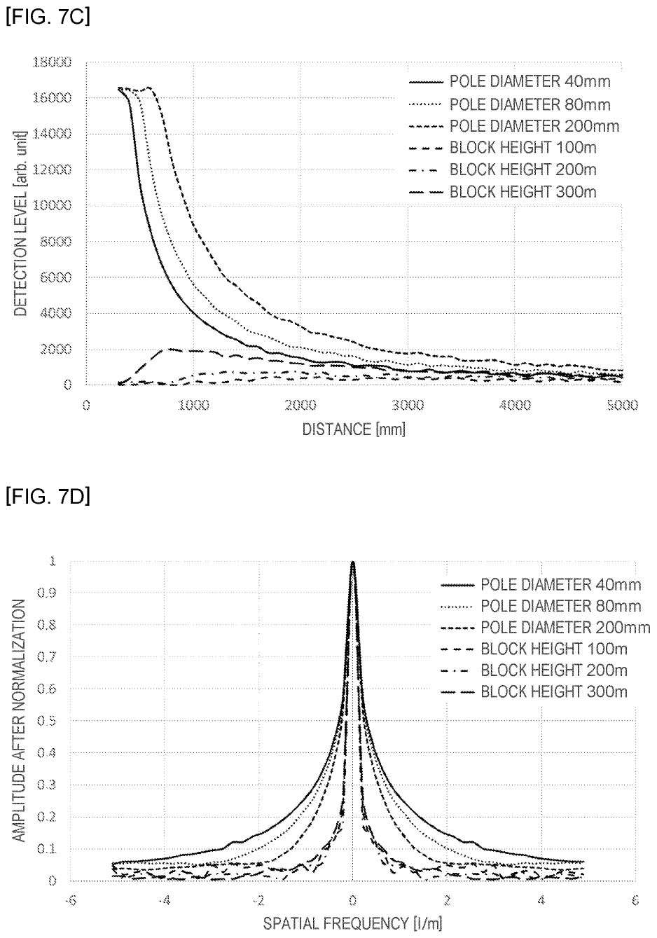

FIGS. 7A to 7D illustrate examples of waveforms when the technical validity of the shape estimation system according to the first embodiment of the present invention is verified by simulation. As objects, calculation was performed for poles and blocks, and three types of poles with diameters of 40 mm, 80 mm, and 200 mm and three types of blocks with heights of 100 mm, 200 mm, and 300 mm were calculated.

FIG. 7A illustrates the relationship between a level value of a scattered/reflected wave calculated by simulation and the distance between a vehicle and an object. As shown in FIG. 7A, it can be seen that the closer the distance between the vehicle and the object is, the more the level value of the scattered/reflected wave basically increases, but because a block enters a blind spot when the distance to the block is too close, the level value of the scattered/reflected wave tends to decrease.

Therefore, the comparison calculation unit 125 is capable of estimating the shape of the detected object 3 after normalizing, using the respective maximum values, the set of spectra and all of the spectra of the detected object 3 which are output from the conversion processing unit 124.

FIG. 7B illustrates a set of spectra after the level value of the scattered wave/reflected wave calculated by the simulation illustrated in FIG. 7A undergoes a Fourier transform into the spatial frequency domain. Note that, in this drawing, the maximum value is normalized to be 1. A principle verification was performed on the premise that this set of spectra is saved as a database.

FIG. 7C illustrates the relationship between the level value of the scattered wave/reflected wave in a measured simulation and the distance between a vehicle and an object. This data is created as data corresponding to actual measurement by superimposing noise on the data calculated by the simulation illustrated in FIG. 7A. Note that, in the principle verification, the noise resistance was examined while changing the amount of noise to be added, and this drawing illustrates an example thereof.

FIG. 7D illustrates a set of spectra after the level value of the scattered wave/reflected wave in the measured simulation illustrated in FIG. 7C undergoes a Fourier transform to the spatial frequency domain. Whether the shape of the object can be correctly estimated was verified by comparing this data with a set of spectra prepared as a database in advance by the simulation illustrated in FIG. 7B.

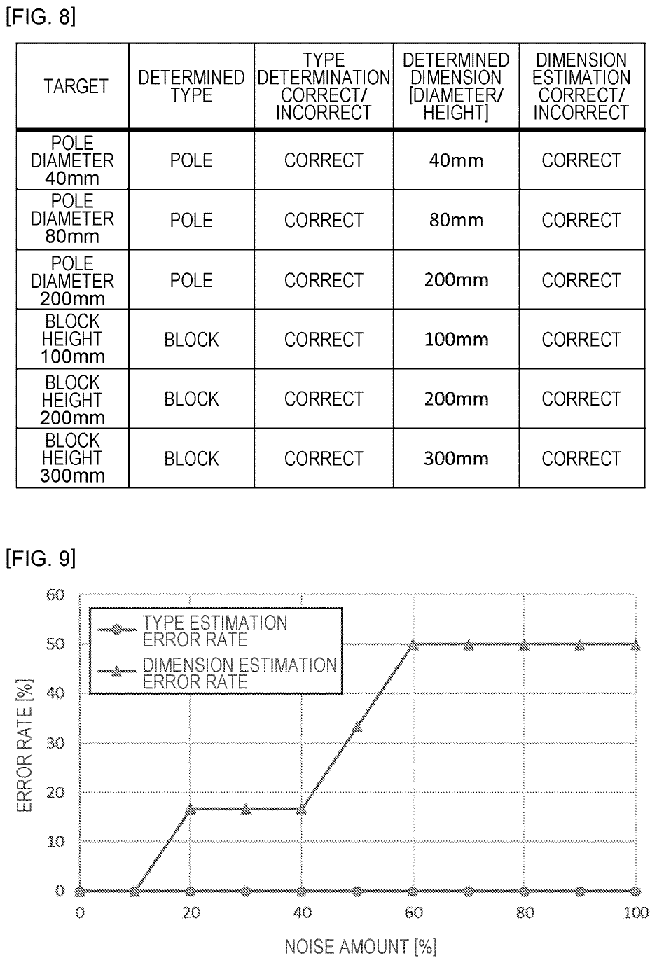

FIG. 8 illustrates an example of an estimation result when the technical validity of the shape estimation system according to the first embodiment of the present invention is verified by simulation. This result shows an estimation result of the data shown in (d) of FIG. 7C. As is clear from FIG. 8, it can be seen that all types and dimensions are correctly estimated, and it can be seen that the shape of the object to be observed can be estimated by employing the present invention.

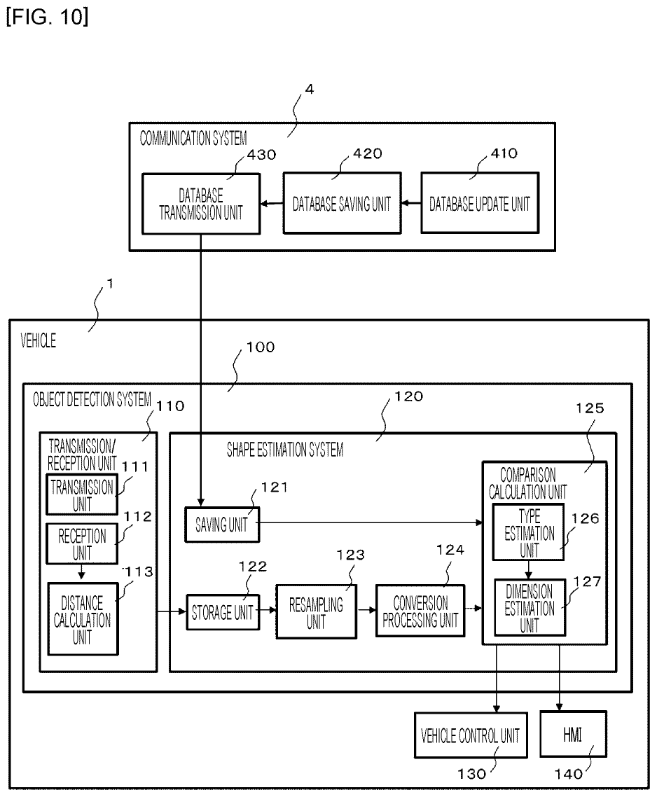

FIG. 9 illustrates an example of a relationship between the error rate and the noise amount when the technical validity of the shape estimation system according to the first embodiment of the present invention is verified by simulation. Here, the amount of noise is expressed as a percentage with the peak value for the level value of scattered/reflected wave at a block height of 100 mm regarded as 100%.

What is particularly noteworthy is that, in the type determination, the type is correctly estimated without any error even if a large amount of noise is superimposed, and it can be said that the technology of the present invention enables the type to be estimated with very high accuracy. Also in the dimension estimation, if the noise amount is less than 20%, the dimensions are correctly estimated without any error, and the dimensions of the object to be observed can be correctly estimated by means of the technology of the present invention.

Furthermore, using the tendency for noise to easily appear on the high-frequency side, there is the possibility of further improving the accuracy of dimension estimation by performing filtering processing like a low-pass filter and separating a signal component and a noise component.

Next, advantageous effects of the present embodiment will be described.

The shape estimation system 120 for vehicle 1 according to the first embodiment of the present invention described above includes the storage unit 122 that stores, as detection data, the distance between the vehicle 1 and the detected object 3, and an amplitude value/intensity value of the reception wave 2B corresponding to the distance, the distance being acquired based on the time from when the transmission wave 2A is transmitted from the transmission unit 111 which transmits the transmission wave 2A to a detection area to be observed to when the reception wave 2B is received by the reception unit 112 which receives the reception wave 2B scattered/reflected from the detected object 3 present in the detection area; the resampling unit 123 that resamples, based on the detection data, an amplitude value/intensity value of the reception wave 2B corresponding to the distance between the vehicle 1 and the detected object 3 as sampling data of a desired distance; the conversion processing unit 124 that converts the resampling data which is output from the resampling unit 123 from a spatial domain into a spatial frequency domain; the saving unit 121 that saves a set of spectra in the spatial frequency domain for a plurality of preset object shapes as a database in association with the object shape; and the comparison calculation unit 125 that estimates the shape of the detected object 3 based on the spectrum of the detected object 3 output from the conversion processing unit 124 and the set of spectra saved in the saving unit 121, wherein the comparison calculation unit 125 estimates, as the shape of the detected object 3, the object shape corresponding to the spectrum, among the set of spectra in the saving unit 121, which is closest to the spectrum of the detected object 3 output from the conversion processing unit 124.

With the present embodiment, there is an advantage that, by utilizing not only actual measurement data but also a database prepared in advance by utilizing simulation or the like, the type/dimensions of the object to be observed can be estimated with higher accuracy than when using the conventionally disclosed estimation techniques. Furthermore, in type estimation in particular, it is shown through principle verification that estimation can be performed with no error even in a case where the amount of noise is large, and hence there is an advantage that high noise resistance can be achieved.

Note that type estimation and dimension estimation can be performed even when a stereo camera/multi-camera is used, but the technology of the present invention has the advantage of being usable even at night or in bad weather, which is one of problems faced by the aforementioned camera technology. Furthermore, by combining detection information detected by a stereo camera/multi-camera with detection information using the present technology, improvements in system accuracy are to be expected.

In addition, although sensing using Lidar is expected in recent years, the technology of the present invention enables a relatively low-cost ultrasonic sonar or the like to be used, and affords the advantage of enabling a system to be constructed at low cost.

Furthermore, although a plurality of transceivers are often utilized in the sensing of the dimension estimation, the technology of the present invention can be implemented by one transceiver and can be implemented by improving the signal processing unit while maintaining the conventionally proposed configuration for the arrangement of transceivers, thus affording the advantages of straightforward introduction and excellent cost performance.

The technology of the present invention is also advantageous in that not only the vehicle control system, but also a clearance sonar the like, which have been widely used heretofore, are capable of notifying the driver of additional information on the type/dimensions of an object.

Furthermore, in conventional scatterometry, the spectral data is acquired by changing the frequency itself of the wave, but the technology of the present invention affords the advantage that the configuration is straightforward because the technology is implemented using spectral data of spatial frequencies by using a wave of a single frequency.

In addition, the resampling unit 123 calculates the sampling data, among the data included in the detection data, by computing the average value of amplitude values/the intensity values of the reception wave 2B which falls within a predetermined distance range from the desired distance, and it is thus possible to reduce the impact of random noise and specific noise.

Furthermore, the conversion processing unit 124 combines the resampling data output from the resampling unit 123 and the data obtained by inverting the sign of the distance of the resampling data, and then performs conversion processing from a spatial domain to a spatial frequency domain, thus making it possible to perform preprocessing of the data suitable for the periodic boundary conditions, and because it is not necessary to intentionally collapse the original detection waveform in a case where the discrete Fourier transform is performed as the conversion processing, accuracy can be improved.

In addition, the comparison calculation unit 125 normalizes, using the respective maximum values, the set of spectra and all of the spectra of the detected object 3 which are output from the conversion processing unit 124, and then estimates the shape of the detected object 3, thus making it possible to handle both an increase and a decrease in the level value of the scattered wave/reflected wave and to realize spectrum processing of the detected object 3 at various heights.

Furthermore, by estimating the type of the detected object 3 as the shape estimation of the detected object 3, the comparison calculation unit 125 is capable of narrowing down the types of the targets for which the dimensions are estimated at the time of the subsequent dimension estimation processing. It is therefore possible to increase the processing speed and further reduce the likelihood of an erroneous determination occurring.

In addition, by estimating at least the curbstone/car stop as the type of the detected object 3, the comparison calculation unit 125 is capable of estimating the shape of a curbstone/car stop with high accuracy, which has conventionally been difficult.

Furthermore, the comparison calculation unit 125 can efficiently improve the accuracy of type estimation by performing machine learning of the features of each type by using a set of spectra as training data and estimating the type from the spectrum of the detected object 3 based on the result of the machine learning.

In addition, the comparison calculation unit 125 calculates, for each type, the average value of the difference between the set of spectra and the spectrum of the detected object 3, and estimates the type for which the average value of this difference is substantially minimum, as the type of the detected object 3, thereby enabling an improvement in the accuracy of the type estimation.

Further, the comparison calculation unit 125 can more accurately estimate what kind of object the detected object 3 is by estimating the dimensions of the detected object 3 as the shape estimation of the detected object 3.

In addition, the comparison calculation unit 125 estimates the type of the detected object 3 at the time of the shape estimation of the detected object 3, and then estimates the dimensions of the detected object 3 after referring only to data, among the set of spectra, related to the identified type of the detected object 3, thus making it possible to realize the estimation processing at a higher speed and with higher accuracy.

Furthermore, the comparison calculation unit 125 estimates that the dimensions at which the difference between the set of spectra and the spectrum of the detected object 3 is minimized are the dimensions of the detected object 3, thus enabling the accuracy of the dimension estimation to be further enhanced.

### Second Embodiment

A shape estimation system, an object detection system, and a communication system, as well as a shape estimation method, an object detection method, and a communication method according to a second embodiment of the present invention will be described with reference to FIG. 10. FIG. 10 is a block diagram illustrating an example of the overall configuration of a vehicle equipped with a shape estimation system and of a communication system according to a second embodiment of the present invention.

As illustrated in FIG. 10, the present embodiment is different from the first embodiment in that a communication system 4 capable of communicating with the saving unit 121 in the vehicle 1 has been added.

The communication system 4 is a system that communicates, via a network, with the vehicle 1 including the object detection system 100, and that includes, for example, a database update unit 410 that updates a database of the database saving unit 420, a database saving unit 420 that saves a database which is used at the time the vehicle 1 estimates the shape of the detected object 3, and a database transmission unit 430 that transmits the database saved in the database saving unit 420 to the saving unit 121 of the vehicle 1.

The database update unit 410 updates, as necessary, a set of spectra in a spatial frequency domain related to various objects which the vehicle should be prepared for as a database in advance. For example, in a case where this database is prepared by simulation, it is conceivable to update the database in a case where the simulation accuracy can be improved as compared with an initial state or in a case where an errors of the database in the initial state becomes a problem.

The database saving unit 420 inputs the database updated by the database update unit 410 and saves the database.

The database transmission unit 430 inputs the database updated by the database saving unit 420 and updates the database saved in the saving unit 121 of the vehicle 1. The database transmission unit 430 desirably transmits the updated database to the vehicle 1 at the time the database update unit 410 updates the database. Here, a configuration without the database saving unit 420 can be realized, but it is desirable that the updated database be managed by the database saving unit 420 in order to be trackable.

Therefore, the database saved in the saving unit 121 can be updated via the communication system 4 or a physical medium.

Other configurations and operations are substantially the same configurations and operations as those of the shape estimation system, the object detection system, and the communication system, as well as the shape estimation method, the object detection method, and the communication method according to the first embodiment described above, and details thereof are omitted.

Also with shape estimation system, the object detection system, and the communication system, as well as the shape estimation method, the object detection method, and the communication method according to the second embodiment of the present invention, advantageous effects substantially similar to those of the shape estimation system, the object detection system, the communication system, the shape estimation method, the object detection method, and the communication method according to the first embodiment described above can be obtained.

In addition, because the set of spectra of the scattered wave/reflected wave prepared in advance as a database can be updated, there is an advantage that it is possible to handle a case where the object shape estimation accuracy becomes a problem or a case where the estimation accuracy can be improved.

Note that, as an example, an example in which the database is updated by means of a communication system has been described, but the database may be updated via a physical medium.

### Additional Remarks

The embodiments of the present invention have been described above. Note that the present invention is not limited to or by the above-described embodiments and includes various modifications and equivalent configurations within the spirit of the appended claims. For example, the above-described embodiments have been described in detail to facilitate understanding of the present invention, but the present invention is not necessarily limited to including all the described configurations. Further, part of the configuration of one embodiment may be replaced with the configuration of another embodiment. In addition, the configuration of another embodiment may be added to the configuration of a certain embodiment. Further, part of the configuration of each embodiment may be added, deleted, or replaced with another configuration.

In addition, some or all of the above-described configurations, functions, processing units, processing means, and the like may be implemented by hardware by means of a design using an integrated circuit, or may be implemented by software as a result of a processor interpreting and executing programs for implementing each function.

Information such as programs, tables, and files for implementing each function can be stored on a storage device such as memory, a hard disk, or an SSD (solid state drive), or on a recording medium such as an IC card, an SD card, or a DVD.

Moreover, control lines and information lines indicate what is deemed necessary for the sake of the description, and do not necessarily represent all the control lines and information lines required for implementation. In practice, almost all the configurations may be considered to be interconnected.

### REFERENCE SIGNS LIST

1 vehicle
2A transmission wave
2B reception wave
3 detected object
4 communication system
100 object detection system
110 transmission/reception unit
111 transmission unit
112 reception unit
113 distance calculation unit
120 shape estimation system
121 saving unit
122 storage unit
123 resampling unit
124 conversion processing unit
125 comparison calculation unit (shape estimation unit)
126 type estimation unit
127 dimension estimation unit
130 vehicle control unit
140 HMI
410 database update unit
420 database saving unit
430 database transmission unit

1. A shape estimation system for a vehicle, the system comprising:
a storage unit that stores, as detection data, the distance between the vehicle and a detected object, and an amplitude value/intensity value of a wave corresponding to the distance, the distance being acquired on a basis of the time from when a transmission wave is transmitted from a transmission unit which transmits the transmission wave to a detection area to be observed to when the wave is received by a reception unit which receives the wave scattered/reflected from the detected object present in the detection area;
a resampling unit that resamples, on a basis of the detection data, an amplitude value/intensity value of the wave corresponding to the distance between the vehicle and the detected object as sampling data of a desired distance;
a conversion processing unit that converts the resampling data which is output from the resampling unit from a spatial domain into a spatial frequency domain;
a saving unit that saves a set of spectra in the spatial frequency domain for a plurality of preset object shapes as a database in association with the object shape; and
a shape estimation unit that estimates the shape of the detected object on a basis of the spectrum of the detected object output from the conversion processing unit and the set of spectra saved in the saving unit,
wherein the shape estimation unit estimates, as the shape of the detected object, the object shape corresponding to the spectrum, among the set of spectra in the saving unit, which is closest to the spectrum of the detected object output from the conversion processing unit.

2. The shape estimation system according to claim 1, wherein the resampling unit calculates the sampling data, among the data included in the detection data, by computing the average value of amplitude values/intensity values of the wave which falls within a predetermined distance range from the desired distance.

3. The shape estimation system according to claim 1, wherein the conversion processing unit performs conversion processing from a spatial domain to a spatial frequency domain after combining the resampling data output from the resampling unit with data obtained by inverting the sign of the distance of the resampling data.

4. The shape estimation system according to claim 1, wherein the shape estimation unit normalizes, using the respective maximum values, the set of spectra and all of the spectra of the detected object which are output from the conversion processing unit, and then estimates the shape of the detected object.

5. The shape estimation system according to claim 1, wherein the shape estimation unit estimates the type of the detected object as the shape estimation of the detected object.

6. The shape estimation system according to claim 5, wherein the shape estimation unit estimates at least a curbstone/car stop as the type of the detected object.

7. The shape estimation system according to claim 5, wherein
the shape estimation unit performs machine learning of the features of each type by using the set of spectra as training data, and estimates the type from the spectrum of the detected object on a basis of the result of the machine learning.

8. The shape estimation system according to claim 5, wherein
the shape estimation unit calculates, for each type, the average value of the difference between the set of spectra and the spectrum of the detected object, and estimates the type for which the average value of this difference is minimum, as the type of the detected object.

9. The shape estimation system according to claim 1, wherein
the shape estimation unit estimates the dimensions of the detected object as the shape estimation of the detected object.

10. The shape estimation system according to claim 1, wherein
the shape estimation unit estimates the type of the detected object at the time of the shape estimation of the detected object, and then estimates the dimensions of the detected object after referring only to data, among the set of spectra, related to the identified type of the detected object.

11. The shape estimation system according to claim 9, wherein
the shape estimation unit estimates that the dimensions at which the difference between the set of spectra and the spectrum of the detected object is minimized are the dimensions of the detected object.

12. The shape estimation system according to claim 1, wherein
the set of spectra is created on a basis of simulation.

13. The shape estimation system according to claim 1, wherein
the set of spectra is created on a basis of actual measurement data.

14. The shape estimation system according to claim 1, wherein
the database saved in the saving unit is updatable via a communication system or a physical medium.

15. The shape estimation system according to claim 1, wherein
the transmission wave transmitted by the transmission unit and the wave received by the reception unit are ultrasonic waves.

16. An object detection system for a vehicle, the system comprising:
a transmission unit that transmits a transmission wave to a detection area to be observed;
a reception unit that receives a wave which is scattered/reflected from a detected object present in the detection area; and
a distance calculation unit that obtains the distance between the vehicle and the detected object based on the time from when the transmission unit transmits the transmission wave to when the reception unit receives the wave; and
the shape estimation system according to claim 1.

17. A communication system that communicates, via a network, with a vehicle including the object detection system according to claim 16, the communication system comprising:
a database saving unit that saves a database which is used at the time the vehicle estimates the shape of a detected object;
a database update unit that updates the database of the database saving unit; and
a database transmission unit that transmits the database saved in the database saving unit to the saving unit of the vehicle,
wherein the database transmission unit transmits an updated database to the vehicle at the time the database update unit updates the database.

18. A shape estimation method for a vehicle, the method comprising:
a storage step of storing, as detection data, the distance between the vehicle and a detected object, and an amplitude value/intensity value of a wave corresponding to the distance, the distance being acquired based on the time from when a transmission wave is transmitted from a transmission unit which transmits the transmission wave to a detection area to be observed to when the wave is received by a reception unit which receives the wave scattered/reflected from the detected object present in the detection area;
a resampling step of resampling, based on the detection data, an amplitude value/intensity value of the wave corresponding to the distance between the vehicle and the detected object as sampling data of a desired distance;
a conversion processing step of converting the resampling data which is output in the resampling step from a spatial domain into a spatial frequency domain;
a saving step of saving a set of spectra in the spatial frequency domain for a plurality of preset object shapes as a database in association with the object shape; and
a shape estimation step of estimating the shape of the detected object based on the spectrum of the detected object output in the conversion processing step and the set of spectra saved in the saving step,
wherein, in the shape estimation step, the object shape corresponding to the spectrum, among the set of spectra saved in the saving step, which is closest to the spectrum of the detected object output in the conversion processing step, is estimated as the shape of the detected object.

19. An object detection method comprising:
a transmission step of transmitting a wave to a detection area to be observed;
a reception step of receiving a wave scattered/reflected from a detected object present in the detection area;
a distance calculation step of obtaining the distance between the vehicle and the detected object based on the time from when the wave is transmitted in the transmission step to when the wave is received in the reception step; and
each step of the shape estimation method according to claim 18.

20. A communication method for communicating via a network with a vehicle including a processing device that executes the shape estimation method according to claim 18, the communication method comprising:
a database saving step of saving a database which is used at the time the vehicle estimates the shape of a detected object;
a database update step of updating the database; and
a database transmission step of transmitting the database to a saving unit of the processing device,
wherein, in the database transmission step, the updated database is transmitted to the saving unit at the time the database is updated in the database update step.
